(19) United States
(12) Patent Application Publication
(10) Pub. No.: US 2026/0010101 A1
(43) Pub. Date: Jan. 8, 2026

(54) FIXING DEVICE AND IMAGE FORMING APPARATUS

(71) Applicant: CANON KABUSHIKI KAISHA, Tokyo (JP)

(72) Inventors: YUSUKE YAMAGUCHI, Chiba (JP); RYO YASHIRO, Tokyo (JP); SHIGEAKI TAKADA, Chiba (JP); AKIHIRO MAEDA, Tokyo (JP); MADOKA WATANABE, Chiba (JP)

(21) Appl. No.: 19/220,604

(22) Filed: May 28, 2025

(30) Foreign Application Priority Data
Jul. 3, 2024 (JP) 2024-107345

(51) Int. Cl. G03G 15/20

(52) U.S. Cl. CPC G03G 15/2025; G03G 15/2064; G03G 2215/2038

(57) ABSTRACT

A fixing device including: a rotatable endless belt member including a first surface that abuts on the recording material and a second surface opposite the first surface and to which a lubricant is applied; a nip forming member provided inside the belt member; a pressure rotating body configured to form a fixing nip portion that nips and conveys the recording material together with the belt member by pressurizing the nip forming member via the belt member; a rotatable rotating member including a third surface that abuts on the second surface of the belt member; and a lubricant regulating member configured to abut on the third surface of the rotating member and provided at a position straddling each of at least both ends of the belt member in a width direction perpendicular to the conveying direction of the recording material, and inclined downstream in a rotation direction of the rotating member toward the central portion in the width direction of the belt member.

### BACKGROUND OF THE INVENTION

### Field of the Invention

The present invention relates to a fixing device that fixes a toner image on a recording material, and an image forming apparatus including the fixing device.

### Description of the Related Art

Conventionally, an image forming apparatus includes a fixing device that fixes an unfixed toner image on a recording material to the recording material. A fixing device described in Japanese Patent Application Laid-Open No. 2003-195671 includes a heating roller having a heating source for heating an unfixed toner image, a rotatable endless fixing belt to which heat is applied from the heating roller, and a pressure roller that pressurizes the fixing belt.

In such a fixing device, the heating roller is disposed inside the fixing belt to suspend the fixing belt. Further, the pressure roller is disposed outside the fixing belt and presses the pad member disposed inside the fixing belt via the fixing belt to form a fixing nip portion together with the fixing belt. Then, the recording material carrying the unfixed toner image is conveyed to the fixing nip portion, and heat and pressure are applied when the recording material is nipped and conveyed in the fixing nip portion. As a result, the toner image on the recording material is fixed to the recording material.

In addition, conventionally, a fixing device has been proposed in which the width of the fixing nip portion in the conveyance direction of the recording material is widened as the printing speed of the image forming apparatus is increased. By widening the width of the fixing nip portion in the conveyance direction of the recording material, the time for applying heat and pressure to the recording material in the fixing nip portion can be increased, and the toner image on the recording material can be reliably fixed to the recording material even when the speed is increased.

On the other hand, in a case where the width of the fixing nip portion in the conveying direction of the recording material is increased, the contact area between the pad member and the fixing belt is increased, and thus the sliding resistance is increased. Therefore, conventionally, there is known a fixing device having a configuration in which a lubricant is applied to an inner circumferential surface of a fixing belt to reduce sliding resistance between the fixing belt and a pad member.

### SUMMARY OF THE INVENTION

A fixing device according to the present invention is a fixing device that fixes a toner image on a recording material, the fixing device including: a rotatable endless belt member including a first surface that abuts on the recording material and a second surface opposite the first surface and to which a lubricant is applied; a nip forming member provided inside the belt member; a pressure rotating body configured to form a fixing nip portion that nips and conveys the recording material together with the belt member by pressurizing the nip forming member via the belt member; a rotatable rotating member including a third surface that abuts on the second surface of the belt member; and a lubricant regulating member configured to abut on the third surface of the rotating member and provided at a position straddling each of at least both ends of the belt member in a width direction perpendicular to the conveying direction of the recording material, and inclined downstream in a rotation direction of the rotating member toward the central portion in the width direction of the belt member.

Further features of the present invention will become apparent from the following description of exemplary embodiments with reference to the attached drawings.

### BRIEF DESCRIPTION OF THE DRAWINGS

FIG. 1 is a schematic diagram of an image forming apparatus according to a first embodiment of the present invention.

FIG. 2 is a cross-sectional view of a fixing device according to the first embodiment of the present invention.

FIG. 3 is a perspective view of a part of the fixing device according to the first embodiment of the present invention.

FIG. 4 is a schematic diagram of a part of the fixing device according to the first embodiment of the present invention.

FIG. 5 is a diagram illustrating a relationship between an idle rotation time and an oil adhesion amount in the fixing device according to the first embodiment of the present invention.

FIG. 6 is a cross-sectional view of a fixing device according to a second embodiment of the present invention.

FIG. 7 is a schematic diagram of a part of the fixing device according to the second embodiment of the present invention.

FIG. 8 is a diagram illustrating relationship between an idle rotation time and an oil adhesion amount of the fixing device according to the second embodiment of the present invention.

### DESCRIPTION OF THE EMBODIMENTS

Hereinafter, embodiments will be described in detail with reference to the drawings.

### First Embodiment

### <Configuration of Image Forming Apparatus>

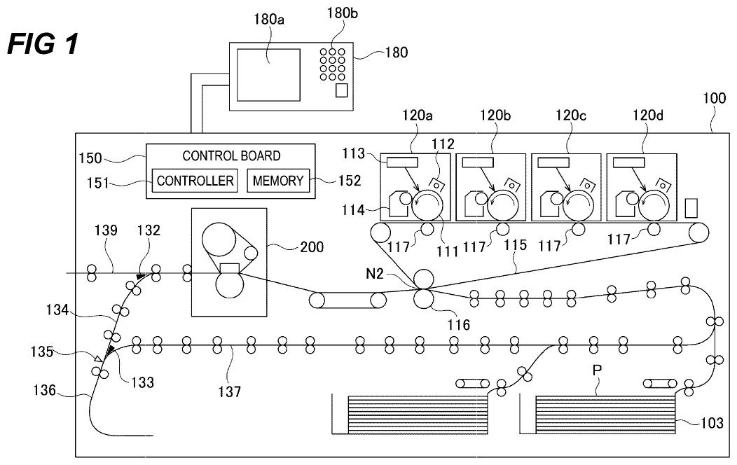

A configuration of an image forming apparatus 100 according to a first embodiment of the present invention will be described in detail with reference to FIG. 1.

Here, the image forming apparatus 100 is exemplified by a full-color image forming apparatus. Specifically, the image forming apparatus 100 includes a recording material cassette 103, an intermediate transfer belt 115, a secondary transfer roller 116, a primary transfer roller 117, an image forming portion 120a, an image forming portion 120b, an image forming portion 120c, and an image forming portion 120d. The image forming apparatus 100 includes a flapper 132, a flapper 133, a reverse sensor 135, a control board 150, an operation portion 180, and a fixing device 200.

The intermediate transfer belt 115, the secondary transfer roller 116, the primary transfer roller 117, and the image forming portions 120a, 120b, 120c, and 120d constitute an image forming unit that forms a toner image on a recording material P and conveys the recording material P on which the toner image has been formed to the fixing device 200.

The recording material cassette 103 accommodates the recording material P.

On the intermediate transfer belt 115, toner images are sequentially primarily transferred from the photosensitive drums 111 of the image forming portion 120a, the image forming portion 120b, the image forming portion 120c, and the image forming portion 120d by the primary transfer roller 117, whereby a full-color toner image is formed. The intermediate transfer belt 115 conveys the formed toner image to the secondary transfer roller 116.

A pair of secondary transfer rollers 116 is provided. The secondary transfer rollers 116 abut on each other via the intermediate transfer belt 115 to form a secondary transfer portion N2. The secondary transfer roller 116 secondarily transfers the toner image formed on the intermediate transfer belt 115 to the recording material P taken out and fed one by one from the recording material cassette 103 in accordance with the conveyance timing of the toner image conveyed by the intermediate transfer belt 115. The secondary transfer roller 116 secondarily transfers the toner image formed on the intermediate transfer belt 115 to the recording material P conveyed from a reverse path 137 in accordance with the conveyance timing of the toner image conveyed by the intermediate transfer belt 115. The secondary transfer roller 116 conveys the recording material P on which the toner image has been secondarily transferred to the fixing device 200.

The image forming portion 120a, the image forming portion 120b, the image forming portion 120c, and the image forming portion 120d are arranged along the moving direction of the intermediate transfer belt 115, whereby a full-color toner image is formed.

The image forming portion 120a forms a yellow toner image and transfers the formed yellow toner image to the intermediate transfer belt 115.

The image forming portion 120b forms a magenta toner image and transfers the formed magenta toner image to the intermediate transfer belt 115.

The image forming portion 120c forms a cyan toner image and transfers the formed cyan toner image to the intermediate transfer belt 115.

The image forming portion 120d forms a black toner image and transfers the formed black toner image to the intermediate transfer belt 115.

Each of the image forming portion 120a, the image forming portion 120b, the image forming portion 120c, and the image forming portion 120d includes a photosensitive drum 111, a charger 112, an exposure device 113, and a developing device 114.

The photosensitive drum 111 is rotationally driven by a drive motor (not illustrated).

The charger 112 uniformly charges the surface of the photosensitive drum 111.

The exposure device 113 forms an electrostatic latent image on the surface of the photosensitive drum 111 by irradiating the surface of the photosensitive drum 111 charged by the charger 112 with a laser according to image data input from a controller 151 described later of the control board 150.

The developing device 114 forms a toner image on the surface of the photosensitive drum 111 by supplying toner to the electrostatic latent image formed on the surface of the photosensitive drum 111 by the exposure device 113.

Each of the image forming portion 120a, the image forming portion 120b, the image forming portion 120c, and the image forming portion 120d includes a toner cleaner (not illustrated) that scrapes off the toner remaining on the surface of the photosensitive drum 111 without being transferred and removes the toner from the surface of the photosensitive drum 111.

The primary transfer roller 117 primarily transfers the toner image on the photosensitive drum 111 to the intermediate transfer belt 115 by applying a voltage having a potential polarity opposite to the potential polarity of the toner image to the intermediate transfer belt 115.

In a case where images are formed on both surfaces of the recording material P, the flapper 132 guides the recording material P on which transfer and fixing of the toner image onto the image forming first surface (first surface) of the recording material P has been completed to the conveyance path 134 and conveys the recording material P to a reverse portion 136 under the control of the controller 151 of the control board 150. The flapper 132 guides, to the discharge path 139, the recording material P on which image formation is performed only on one surface, or the recording material P on which image formation is performed on both surfaces of the recording material P and the transfer and fixing of the toner image onto the image formation second surface (second surface) of the recording material P is completed.

The flapper 133 performs switching such that the recording material P is conveyed from the reverse portion 136 to the reverse path 137 under the control of the controller 151 of the control board 150.

The reverse sensor 135 detects a rear end of the recording material P conveyed to the reverse portion 136 by the fixing device 200 in the conveyance direction, and outputs an electric signal corresponding to the detection result to the controller 151 of the control board 150.

The control board 150 controls the entire operation of the image forming apparatus 100 based on an electric signal input from the operation portion 180. The control board 150 includes a controller 151 and a memory 152.

The controller 151 controls the operation of the image forming apparatus 100 based on an electric signal input from a selection key 180b described later of the operation portion 180 and information data stored in the memory 152. The controller 151 performs control for displaying the state of the image forming apparatus 100 on a display screen 180a of the operation portion 180. In a case where the electric signal input from the reverse sensor 135 indicates the detection result of detecting the rear end of the recording material P in the conveyance direction, the controller 151 performs control to switch the flapper 133 such that the recording material P is conveyed from the reverse portion 136 to the reverse path 137. The controller 151 writes information data in the memory 152.

The memory 152 stores information data necessary for control by the controller 151.

The operation portion 180 includes the display screen 180a that displays a state of the image forming apparatus 100, and the selection key 180b that receives an instruction of an operation from an operator such as a user and outputs an electric signal corresponding to the received instruction to the control board 150.

The fixing device 200 applies heat and pressure to the recording material P conveyed by the secondary transfer roller 116 to fix the toner image secondarily transferred to the recording material P by the secondary transfer roller 116 to the recording material P. The fixing device 200 conveys the recording material P on which the toner image is fixed to the discharge path 139 and discharges the recording material P to a discharge tray (not illustrated). Note that details of the configuration of the fixing device 200 will be described later.

In the image forming apparatus 100 having the above configuration, a process from the charging process of charging the photosensitive drum 111 to the discharge of the recording material P on which the toner image is fixed is referred to as an image forming process (print job). In addition, the image forming apparatus 100 is in the middle of image forming processing (during print job) in a period in which image formation is performed.

Note that the image forming apparatus 100 is not limited to full-color image formation, and can perform monochrome image formation. When a monochrome image is formed, only the image forming portion 120d that forms a black toner image is driven.

### <Configuration of Fixing Device>

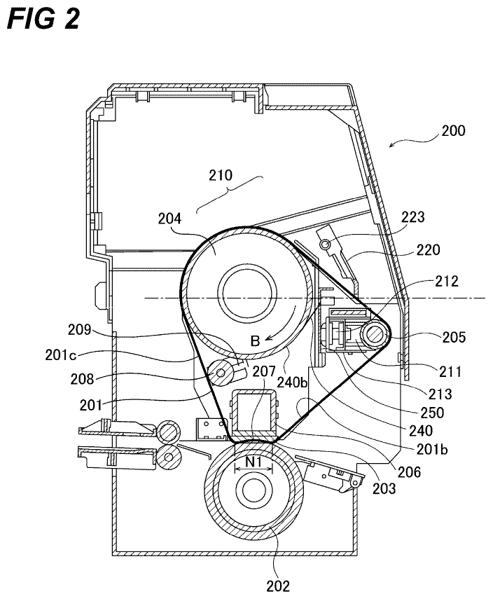

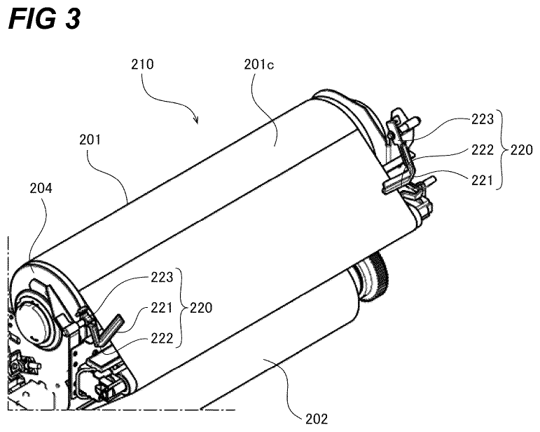

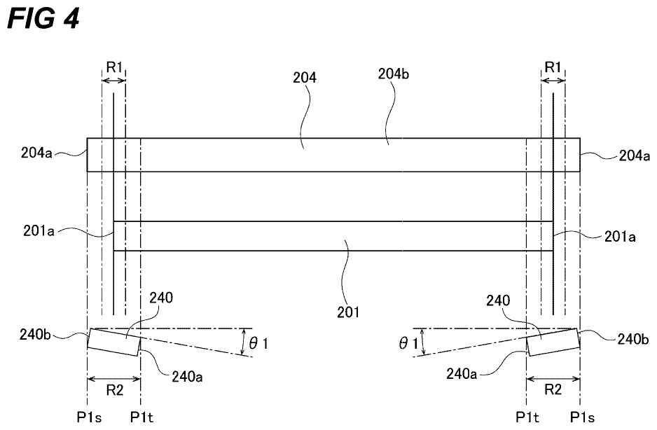

A configuration of the fixing device 200 according to the first embodiment of the present invention will be described in detail with reference to FIGS. 2 to 4. The recording material P is conveyed in the left direction in FIG. 2. Here, the width direction (hereinafter, simply referred to as “width direction”) orthogonal to the conveyance direction of the recording material P is a direction orthogonal to the paper surface in FIG. 2, and is a left-right direction in FIG. 4.

The fixing device 200 includes a pressure roller 202, a stay 206, a heating unit 210, a spring 211, a steering frame 213, a collection mechanism 220, an oil regulating member 240, and a steering attachment member 250.

Note that FIG. 4 is a view of the fixing device 200 as viewed from the right side of FIG. 2. Further, in FIG. 4, the heating roller 204 is covered with the fixing belt 201 at the center in the width direction, but for convenience of description, the description of the covered part of the heating roller 204 of the fixing belt 201 is omitted. In addition, the fixing belt 201 is actually a belt-shaped member as illustrated in FIG. 2, but is depicted as a roller-shaped member for convenience of description in FIG. 4. In FIG. 4, positions other than the position in the width direction of the oil regulating member 240 with respect to the fixing belt 201 and the heating roller 204 are described to be different from actual positions for convenience of description. Further, in FIG. 4, the fixing belt 201 and the heating roller 204 rotate from the back side to the front side with respect to the paper surface.

The pressure roller 202 as a pressure rotating body is a roller formed by laminating an elastic layer provided on the outer periphery of a shaft and a release layer provided on the outer periphery of the elastic layer. The shaft is made of stainless steel. The elastic layer has a thickness of 5 mm and is formed of conductive silicone rubber. The release layer has a thickness of 50 μm and is formed of PFA as a fluororesin.

The pressure roller 202 is rotatably supported by a fixing frame (not illustrated) of the fixing device 200. A gear (not illustrated) is fixed to one end of the pressure roller 202 in the longitudinal direction, and the pressure roller is connected to a drive source (not illustrated) via the gear. The pressure roller 202 is rotationally driven via the gear when the drive source is driven. The pressure roller 202 forms a fixing nip portion N1 that nips and conveys the recording material P together with the fixing belt 201 by pressurizing the pad member 203 via the fixing belt 201 described later of the heating unit 210.

The stay 206 is disposed inside the fixing belt 201 of the heating unit 210, and is provided on a side of the pad member 203 of the heating unit 210 opposite to a side where the sliding sheet 207 is provided. The stay 206 is provided to back up the pad member 203, and is a reinforcing member having rigidity with the width direction as the longitudinal direction. When the pad member 203 is pressed by the pressure roller 202, the stay 206 prevents the deflection of the pad member 203 to secure the pressure in the fixing nip portion N1.

The stay 206 is made of a pull-out material of SUS304 having a wall thickness of 3 mm, and has a hollow inside and is formed to have a square cross section to secure strength. The material of the stay 206 is not limited to stainless steel as long as the strength can be secured, and may be other than stainless steel.

The heating unit 210 includes a heat source and heats the recording material P at the fixing nip portion N1. The heating unit 210 includes a fixing belt 201, a pad member 203, a heating roller 204, a steering roller 205, a sliding sheet 207, an oil applying roller 208, and a pressing spring 209.

The fixing belt 201 as a belt member has a three-layer structure in which a base layer, an elastic layer covering an outer periphery of the base layer, and a release layer covering an outer periphery of the elastic layer are laminated. The base layer has a thickness of 60 μm and is made of polyimide resin (PI). The elastic layer has a thickness of 300 μm and is made of silicone rubber. The release layer has a thickness of 30 μm and is made of PFA (tetrafluoroethylene-perfluoroalkoxyethylene copolymer resin) as a fluororesin.

The fixing belt 201 has thermal conductivity, heat resistance, and the like, and has a thin cylindrical shape with the width direction as the longitudinal direction. The fixing belt 201 is stretched by the pad member 203, the heating roller 204, and the steering roller 205. The fixing belt 201 stores heat from the heating roller 204 by being heated by the heating roller 204.

The fixing belt 201 is endless and rotatable, and is sandwiched between the pressure roller 202 and the pad member 203 at the fixing nip portion N1, thereby being driven to rotate in the B direction of FIG. 2 when the pressure roller 202 rotates. The fixing belt 201 includes an outer circumferential surface 201c as a first surface abutting on the recording material P at the fixing nip portion N1, and an inner circumferential surface 201b as a second surface opposite to the outer circumferential surface 201c. Oil S is applied to the inner circumferential surface 201b of the fixing belt 201 by the oil applying roller 208. The force applied to the fixing belt 201 at the fixing nip portion N1 is exemplified here as about 2000 N.

The pad member 203 as a nip forming member is provided inside the fixing belt 201 to suspend the fixing belt 201. The pad member 203 is a member that is in press contact with the pressure roller 202 via the fixing belt 201 to form the fixing nip portion N1 having a predetermined width in the conveyance direction of the recording material P. The pad member 203 has a substantially rectangular cross section with the width direction as the longitudinal direction. The pad member 203 is made of a material having heat resistance, and is made of, for example, liquid crystal polymer (LCP) resin.

The heating roller 204 as the rotating member is a stainless pipe having a thickness of 1 mm with the width direction as the longitudinal direction. The heating roller 204 includes a halogen heater (not illustrated) inside, and can generate heat to a predetermined temperature by the halogen heater. The heating roller 204 is provided inside the fixing belt 201 to suspend the fixing belt 201. The heating roller 204 is a rotatable heating member that warms the fixing belt 201. The surface 204b as the third surface of the heating roller 204 abuts on the inner circumferential surface 201b of the fixing belt 201.

The length of the heating roller 204 in the width direction is larger than the length of the fixing belt 201 in the width direction. An end 204a of the heating roller 204 in the width direction is located outside in the width direction than the end 201a of the fixing belt 201 in the width direction (see FIG. 4). The length of the heating roller 204 in the width direction is not limited to be larger than the length of the fixing belt 201 in the width direction, and may be the same length as the length of the fixing belt 201 in the width direction.

The steering roller 205 has the width direction as the longitudinal direction, is provided inside the fixing belt 201 to suspend the fixing belt 201, and is rotatably supported by the steering frame 213. The steering roller 205 is biased to the fixing belt 201 by the spring 211 supported by the steering frame 213, and also serves as a tension roller that applies a predetermined tension to the fixing belt 201. A surface 205b of the steering roller 205 abuts on the inner circumferential surface 201b of the fixing belt 201 by the steering roller 205 being biased to the fixing belt 201 by the spring 211.

The steering roller 205 rotates together with the steering frame 213 about a rotation shaft 212 whose axial direction is the conveyance direction of the recording material P, thereby performing a steering operation in which both ends in the width direction swing in a vertical direction (vertical direction in FIG. 2). The steering roller 205 performs a steering operation to move the fixing belt 201 to a predetermined position in the width direction.

The length of the steering roller 205 in the width direction is larger than the length of the fixing belt 201 in the width direction, and is equal to the length of the heating roller 204 in the width direction. The end 205a of the steering roller 205 in the width direction is located outside the end 201a of the fixing belt 201 in the width direction.

The length of the steering roller 205 in the width direction and the length of the heating roller 204 in the width direction are not limited to the same size, and may be different sizes. The length of the steering roller 205 in the width direction is not limited to be larger than the length of the fixing belt 201 in the width direction, and may be the same length as the length of the fixing belt 201 in the width direction.

The sliding sheet 207 is provided between the fixing belt 201 and the pad member 203. The sliding sheet 207 is formed by coating a surface of a polyimide base material having a thickness of 70 μm with PTFE.

The oil applying roller 208 is formed by impregnating a roll-shaped member around which a nonwoven fabric having a thickness of 100 μm is wound with the oil S such as silicone oil as a lubricant. The oil applying roller 208 is rotatably supported by a frame (not illustrated) of the heating unit 210. The oil applying roller 208 abuts on the inner circumferential surface 201b of the fixing belt 201 to supply the oil S to the inner circumferential surface 201b of the fixing belt 201.

The pressing spring 209 biases the oil applying roller 208 so that the oil applying roller 208 abuts on the inner circumferential surface 201b of the fixing belt 201. Here, 3.0 N is exemplified as the contact force of the oil applying roller 208 with respect to the inner circumferential surface 201b of the fixing belt 201.

The spring 211 is supported by the steering frame 213, and biases the steering roller 205 against the inner circumferential surface 201b of the fixing belt 201 so that the fixing belt 201 has a predetermined tension.

The steering frame 213 rotates with respect to the frame of the heating unit 210 about the rotation shaft 212 as a rotation center to change alignment of the steering roller 205 with respect to other suspension members. The steering frame 213 changes the alignment of the steering roller 205 with respect to the other suspension member to generate a tension difference between one end side and the other end side in the width direction of the fixing belt 201, and controls the position of the fixing belt 201 in the width direction.

The collection mechanism 220 is disposed at both ends in the width direction, and collects the oil S adhering to the outer circumferential surface 201c of both ends 201a of the fixing belt 201. The collection mechanism 220 includes a scraping member 221, a dropping member 222, and a support member 223.

The scraping member 221 abuts on the end 201a of the fixing belt 201. The scraping member 221 is disposed between the heating roller 204 and the steering roller 205 in the rotation direction of the fixing belt 201. The scraping member 221 scrapes off the oil S adhering to the vicinity of the end 201a of the outer circumferential surface 201c of the fixing belt 201.

The dropping member 222 drops the oil S scraped by the scraping member 221. The dropping member 222 is disposed between the heating roller 204 and the steering roller 205 in the rotation direction of the fixing belt 201.

The support member 223 supports the scraping member 221 such that the scraping member 221 can follow the reciprocating movement of the fixing belt 201 in the width direction.

The oil regulating member 240 as a lubricant regulating member is a sheet-like member such as a fluororubber sheet. The oil regulating member 240 is attached to a positioning member (not illustrated) fixed to the steering attachment member 250. The oil regulating member 240 abuts on the surface 204b of the heating roller 204.

A pair of oil regulating members 240 is provided at the position corresponding to the positions straddling both ends 201a of the fixing belt 201 in the width direction. Note that the oil regulating member 240 is not limited to the configuration in which a pair is provided, and may be one member that straddles both ends 201a of the fixing belt 201 in the width direction.

The oil regulating member 240 is in contact with the heating roller 204 in a contact region R2 between a start point Pls and an end point P1t. Here, the start point Pls is a position outside the fixing belt 201 in the width direction and is a position of the end 201a of the heating roller 204. In addition, the end point P1t is a position closer to the center than the end 201a of the fixing belt 201 in the width direction. The oil regulating member 240 is provided so as to abut on the surface 204b of the heating roller 204 in the contact region R2, and thus, is provided at a position straddling the movement range R1 in the width direction of each of both ends 201a of the fixing belt 201 in the width direction. The oil regulating member 240 is provided so as to straddle the movement range R1 of the end in the width direction of the fixing belt 201 when the fixing belt 201 moves in the width direction by the swing of the steering roller 205. The oil regulating member 240 scrapes off the lubricant adhering to the outer region of the fixing belt 201 in the heating roller 204 in the axial direction of the heating roller 204. Here, the axial direction of the heating roller 204 is a direction parallel to the width direction of the fixing belt 201 and a direction orthogonal to the conveyance direction.

The oil regulating member 240 is provided at a predetermined angle θ1 with respect to the width direction by being inclined to the downstream in the rotation direction of the heating roller 204 toward the central portion in the width direction of the heating roller 204. The oil regulating member 240 is provided to have a predetermined angle θ1 with respect to the width direction by being disposed such that the end 240a on the end point P1t side is located downstream of the end 240b on the start point Pls side in the rotation direction of the heating roller 204. The predetermined angle θ1 is exemplified here as 10 degrees.

Although the start point Pls is located at the position corresponding to the position of the end 204a of the heating roller 204 in the width direction, the present invention is not limited thereto, and the start point Pls may be located outside the end 204a of the heating roller 204 in the width direction. In this case, the end 240b of the oil regulating member 240 is positioned outside the heating roller 204 in the width direction. The oil regulating member 240 preferably abuts on the surface 204b at least up to the end 204a of the heating roller 204.

The oil regulating member 240 regulates movement of the oil S from the heating roller 204 to the fixing belt 201 so that the oil S adhering to the surface 204b of the heating roller 204 does not adhere to the outer circumferential surface 201c of the fixing belt 201.

The steering frame 213 is attached to the steering attachment member 250 so as to be swingable up and down, and the oil regulating member 240 is attached thereto via a positioning member (not illustrated).

Although the oil S is used as the lubricant in the fixing device 200 having the above configuration, the invention is not limited thereto, and grease or the like may be used as the lubricant.

In addition, the sliding sheet 207 is used to improve the slidability between the pad member 203 and the fixing belt 201, but the present invention is not limited thereto, and coating or the like for improving the slidability may be applied to the surface layer of the pad member 203 that abuts on the fixing belt 201.

Further, the heating roller 204 may be configured to be rotationally driven. In this case, when the heating roller 204 rotates at a rotation speed faster than the rotation speed of the pressure roller 202, the tension of the fixing belt 201 from the fixing nip portion N1 to the heating roller 204 can be increased in the rotation direction of the fixing belt 201. As a result, the curvature of the outlet of the fixing nip portion N1 can be increased in the rotation direction of the fixing belt 201, and the separation performance of the recording material P can be improved.

### <Basic Operation of Fixing Device>

A basic operation of the fixing device 200 according to the first embodiment of the present invention will be described in detail with reference to FIGS. 2 to 4.

The heating roller 204 is controlled such that the fixing belt 201 has a predetermined target temperature corresponding to the sheet type based on the temperature of the fixing device 200 detected by a thermistor (not illustrated) indicated by an electric signal input from the thermistor to the controller 151.

The fixing belt 201 is heated by the heating roller 204 while rotating.

Then, when the recording material P carrying the unfixed toner image is nipped and conveyed by the pressure roller 202 and the heated fixing belt 201 at the fixing nip portion N1, heat and pressure necessary for fixing are applied to the recording material P. As a result, the unfixed toner image on the recording material P is fixed to the recording material P. At this time, the fixing belt 201 can smoothly slide with respect to the pad member 203 by interposing the sliding sheet 207 and the oil S between the fixing belt and the pad member 203.

Here, the oil S applied between the pad member 203 and the fixing belt 201 deteriorates with the operation of the fixing device 200 and decreases by leaking to the outside or the like. When the oil S cannot be held between the pad member 203 and the fixing belt 201, the sliding resistance between the pad member 203 and the fixing belt 201 increases, and a problem such as a driven rotation failure of the fixing belt 201 may occur.

On the other hand, when the oil applying roller 208 abuts on the inner circumferential surface 201b of the fixing belt 201, the oil S can be supplied to the inner circumferential surface 201b of the fixing belt 201. As a result, the oil S interposed between the fixing belt 201 and the pad member 203 (sliding sheet 207) can be maintained for a longer time, and the stable operation of the fixing device 200 can be maintained.

Further, when the unfixed toner image is fixed on the recording material P, a portion of the fixing belt 201 which is in contact with the edge which is an end of the recording material P in the width direction is subjected to a larger stress than a portion of the fixing belt 201 which is not in contact with the edge of the recording material P. A region through which the edge of the recording material P of the fixing belt 201 repeatedly passes has a recessed shape as compared with a region of the fixing belt 201 not in contact with the edge of the recording material P. The recess generated in the fixing belt 201 by the edge of the recording material P in this manner is referred to as a paper edge damage.

When pressure and heat are applied to the recording material P in order to fix the unfixed toner image on the recording material P in the fixing device 200, the state of the fixing belt 201 is reflected on the gloss of the surface of the image fixed to the recording material P. In a case where the fixing belt 201 has unevenness, the state of the unevenness of the fixing belt 201 is reflected on the gloss of the surface of the image to be fixed on the recording material P. Therefore, gloss unevenness occurs on the surface of the image fixed to the recording material P. Therefore, in a case where the unfixed toner image is fixed on the recording material P in a state where the fixing belt 201 has a paper edge damage, gloss unevenness in which a straight line is drawn on the surface of the image fixed to the recording material P occurs.

Therefore, in order to suppress the paper edge damage of the fixing belt 201, the fixing belt 201 is reciprocated in the width direction by the steering roller 205. As a result, it is possible to reduce the recording material P repeatedly passing through the same position of the fixing belt 201, and it is possible to suppress the paper edge damage generated in the fixing belt 201. As described above, the steering roller 205 also plays a role of suppressing gloss unevenness due to the edge of the recording material P.

The position of the fixing belt 201 in the width direction is detected by a belt position detection portion (not illustrated). Specifically, the belt position detection portion includes an arm that rotates about a rotation axis whose axial direction is a direction parallel to the width direction and a direction orthogonal to the conveyance direction of the fixing belt 201. The arm of the belt position detection portion rotates about the rotation axis to apply a force in a direction from the outside to the inside to the end 201a in the width direction of the fixing belt 201.

The belt position detection portion detects a position in the width direction of the arm abutting on the end 201a of the fixing belt 201 in the width direction by a sensor such as a photointerrupter, and outputs an electric signal corresponding to the detection result to the controller 151. As a result, the controller 151 can ascertain the position of the fixing belt 201 in the width direction.

Based on the detection result indicated by the electric signal input from the belt position detection portion, the controller 151 performs steering control for causing the steering roller 205 to perform a steering operation of rotating and swinging with the rotation shaft 212 as a rotation center. As a result, it is possible to prevent the fixing belt 201 from coming off from the pad member 203 that suspends the fixing belt 201, the heating roller 204, and the steering roller 205. In addition, the fixing belt 201 can be moved in the width direction in order to take measures against the edge damage.

### <Oil Regulating Operation of Fixing Device>

The oil regulating operation of the fixing device 200 according to the first embodiment of the present invention will be described in detail with reference to FIGS. 2 to 5.

Since the pressing force is generated by the pad member 203 and the pressure roller 202 at the fixing nip portion N1 with respect to the oil S applied to the inner circumferential surface 201b of the fixing belt 201, a force pushed out from the inner circumferential surface 201b of the fixing belt 201 acts at the fixing nip portion N1. As a result, the oil S is exposed to both ends 201a, the side surface, or the region outside both ends 201a of the fixing belt 201.

The oil S exposed in the side surface or the region outside both ends 201a of the fixing belt 201 adheres to the vicinity of the end 204a of the front surface 204b of the heating roller 204 as the fixing belt 201 rotates. Further, the fixing belt 201 reciprocates in the width direction by the steering operation of the steering roller 205.

There is a possibility that the oil S adhering to the vicinity of the end 204a of the front surface 204b of the heating roller 204 may adhere to the outer circumferential surface 201c of the fixing belt 201 in a case where the oil regulating member 240 is not provided, as the fixing belt 201 reciprocates in the width direction.

Then, the oil S adhering to the outer circumferential surface 201c of the fixing belt 201 reaches the fixing nip portion N1 as the fixing belt 201 rotates in the B direction of FIG. 2. The oil S that has reached the fixing nip portion N1 adheres to the recording material P conveyed to the fixing nip portion N1. In this case, the region of the recording material P to which the oil S adheres becomes a fixing failure in which heat transfer is hindered and the toner is not sufficiently melted, or an image failure such as gloss unevenness due to a change in gloss feeling caused by the oil S.

In addition, since the fixing device 200 aggressively reciprocates the fixing belt 201 in the width direction by the steering roller 205 in order to suppress the paper edge damage of the fixing belt 201, the exposure of the oil S is promoted. Therefore, it is necessary to suppress the oil S from adhering to the region of the fixing belt 201 in contact with the recording material P.

In the present embodiment, the oil S adhering to the surface 204b of the heating roller 204 from the inner circumferential surface 201b of the fixing belt 201 is moved from the end 240b of the oil regulating member 240 in contact with the surface 204b toward the end 240a at a predetermined angle θ1. As a result, the oil S adhering to the surface 204b of the heating roller 204 from the inner circumferential surface 201b of the fixing belt 201 can be suppressed from flowing around the outer circumferential surface 201c of the fixing belt 201.

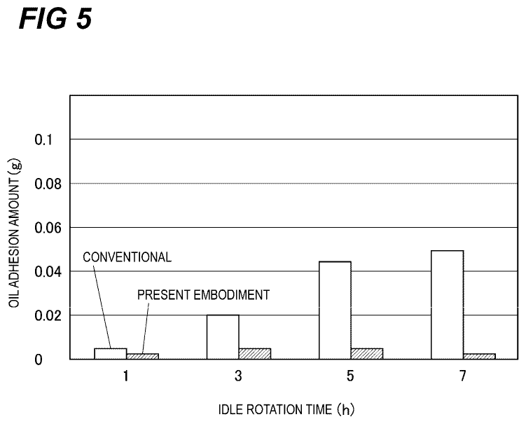

FIG. 5 is a comparison of the amount of oil adhering to the outer circumferential surface 201c of the fixing belt 201 between the conventional fixing device not provided with the oil regulating member 240 and the fixing device 200 of the present embodiment provided with the oil regulating member 240. In addition, the oil adhesion amount on the vertical axis in FIG. 5 is the amount of the oil S that has flown around and adhered to the outer circumferential surface 201c of the fixing belt 201 when the fixing device 200 is idly rotated in a state where the pad member 203 is pressurized by the pressure roller 202.

As conditions of idle rotation of the fixing device 200, the operation speed of the fixing device 200 was set to 630 mm/s, and the temperature adjustment temperature of the heating roller 204 was set to 175° C. In addition, the amount of oil that flowed around the outer circumferential surface 201c of the fixing belt 201 was confirmed 1 hour, 3 hours, 5 hours, and 7 hours after the start of idle rotation.

In the conventional case, it can be confirmed from FIG. 5 that the oil S on the inner circumferential surface of the fixing belt gradually moves to the outer circumferential surface of the fixing belt and accumulates on the surface of the heating roller as the idle rotation time increases.

On the other hand, in the fixing device 200 of the present embodiment, the oil regulating member 240 can control the oil S to be accumulated in the vicinity of the end 204a of the surface 204b of the heating roller 204 to be returned toward the center in the width direction. Accordingly, in the fixing device 200 of the present embodiment, the oil S hardly accumulates the vicinity of the end 204a of the surface 204b of the heating roller 204. Therefore, in the fixing device 200 of the present embodiment, even when the oil S is exposed to the outside of the end 201a of the fixing belt 201, the adhesion amount of the oil S to the outer circumferential surface 201c of the fixing belt 201 can be reduced by the oil regulating member 240.

As described above, by providing the oil regulating member 240 with respect to the heating roller 204 abutting on the fixing belt 201, it is possible to suppress the oil S from flowing around the outer circumferential surface 201c of the fixing belt 201 and to suppress the deterioration of the image quality.

In the fixing device 200, the oil regulating member 240 abuts on at least the end 204a of the front surface 204b of the heating roller 204, so that the oil S to be accumulated in the vicinity of the end 204a can flow to the central portion in the width direction of the heating roller 204. As a result, the oil S adhering to the vicinity of the end 204a of the heating roller 204 can be reliably suppressed from moving to the outer circumferential surface 201c of the fixing belt 201.

Incidentally, the oil S slightly adhering to the vicinity of the end 201a of the outer circumferential surface 201c of the fixing belt 201 is scraped off by the scraping member 221 of the collection mechanism 220 and dropped by the dropping member 222.

In the present embodiment, the oil regulating member 240 is provided so as to abut on the front surface 204b of the heating roller 204 and is provided at a position straddling at least both ends 201a in the width direction of the fixing belt 201. The oil regulating member 240 is inclined to the downstream in the rotation direction of the heating roller 204 toward the central portion in the width direction of the fixing belt 201. As a result, it is possible to suppress the oil S from adhering to the surface of the fixing belt 201 that abuts on the recording material P, and thus, it is possible to suppress the adhesion of the oil S to the recording material P and to suppress deterioration of image quality.

In the present embodiment, a fluorine rubber sheet is used as the oil regulating member 240, but the present invention is not limited thereto, and a member other than the fluorine rubber sheet may be used as the oil regulating member 240.

In the present embodiment, the abutting position of the oil regulating member 240 with respect to the heating roller 204 can be set to any position.

In the present embodiment, the angle of the oil regulating member 240 with respect to the width direction is set to 10 degrees, but the present invention is not limited thereto, and the angle of the oil regulating member 240 with respect to the width direction can be set to an angle other than 10 degrees.

### Second Embodiment

Since the configuration of the image forming apparatus according to a second embodiment of the present invention is the same as that of FIG. 1, the description thereof will be omitted.

### <Configuration of Fixing Device>

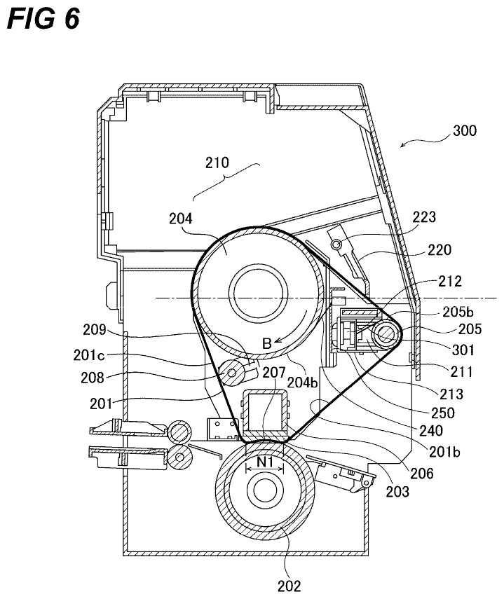

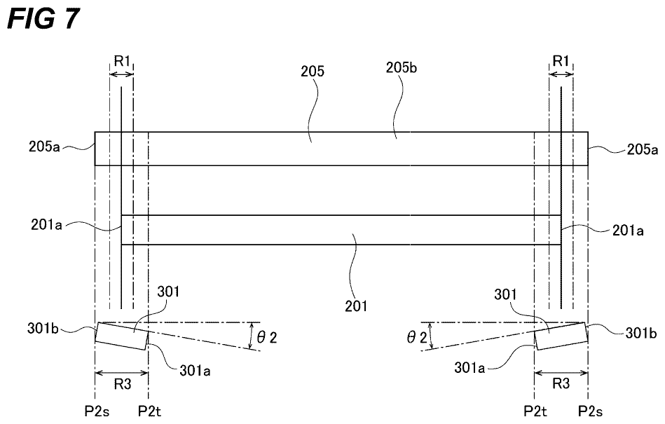

A configuration of the fixing device 300 according to the second embodiment of the present invention will be described in detail with reference to FIGS. 6 and 7. The recording material P is conveyed in the left direction in FIG. 6. In FIGS. 6 and 7, parts having the same configurations as those in FIGS. 2 and 4 are denoted by the same reference numerals, and the description thereof will be omitted.

The fixing device 300 includes a pressure roller 202, a stay 206, a heating unit 210, a spring 211, a steering frame 213, an oil regulating member 240, a steering attachment member 250, and an oil regulating member 301.

Note that FIG. 7 is a view of the fixing device 300 as viewed from the right side of FIG. 6. Further, in FIG. 7, the steering roller 205 is covered with the fixing belt 201 at the center in the width direction, but for convenience of description, the description of the covered part of the steering roller 205 of the fixing belt 201 is omitted. In FIG. 7, similarly to FIG. 4, the fixing belt 201 is illustrated as a roller-shaped member for convenience of description. In addition, in FIG. 7, positions other than the position in the width direction of the oil regulating member 301 with respect to the fixing belt 201 and the steering roller 205 are described to be different from actual positions for convenience of description. Further, in FIG. 7, the fixing belt 201 and the steering roller 205 rotate from the back side to the front side with respect to the paper surface.

The oil regulating member 301 as a lubricant regulating member is a sheet-like member such as a fluororubber sheet. The oil regulating member 301 is attached to the steering frame 213. The oil regulating member 301 abuts on the surface 205b of the steering roller 205.

A pair of oil regulating members 301 is provided at the position corresponding to the positions straddling both ends 201a of the fixing belt 201 in the width direction. Note that the oil regulating member 301 is not limited to the configuration in which a pair is provided, and may be one member that straddles both ends 201a in the width direction of the fixing belt 201 in the width direction.

The oil regulating member 301 is in contact with the surface 205b as the third surface of the steering roller 205 as the rotating member in the contact region R3 between the start point P2s and the end point P2t. Here, the start point P2s is a position outside the fixing belt 201 in the width direction and is a position corresponding to the end 205a of the steering roller 205. Further, the end point P2t is a position closer to the center than the end 201a of the fixing belt 201 in the width direction.

The oil regulating member 301 is provided at a predetermined angle θ2 with respect to the width direction by being inclined to the downstream in the rotation direction of the steering roller 205 toward the central portion in the width direction of the steering roller 205. The oil regulating member 301 has a predetermined angle θ2 with respect to the width direction by being disposed such that the end 301a on the end point P2t side is located downstream of the end 301b on the start point P2s side in the rotation direction of the steering roller 205. The predetermined angle θ2 is exemplified here as 10 degrees.

Although the start point P2s is located at the position corresponding to the position of the end 205a of the steering roller 205 in the width direction, the present invention is not limited thereto, and the start point P2s may be located outside the end 205a of the steering roller 205 in the width direction. In this case, the end 301b of the oil regulating member 301 is positioned outside the steering roller 205 in the width direction. The oil regulating member 301 preferably abuts on the surface 205b at least up to the end 205a of the steering roller 205.

The oil regulating member 301 regulates the movement of the oil S from the steering roller 205 to the fixing belt 201 so that the oil S adhering to the steering roller 205 does not adhere to the outer circumferential surface 201c of the fixing belt 201.

Since the basic operation of the fixing device 300 is the same as the basic operation of the fixing device 200 according to the first embodiment, the description thereof will be omitted.

### <Oil Regulating Operation of Fixing Device>

The oil regulating operation of the fixing device 200 according to the second embodiment of the present invention will be described in detail with reference to FIGS. 6 to 8.

The oil S exposed in the side surface or the region outside both ends 201a of the fixing belt 201 adheres to the vicinity of the end 205a of the steering roller 205 in addition to the vicinity of the end 204a of the front surface 204b of the heating roller 204 as the fixing belt 201 rotates. Further, the fixing belt 201 reciprocates in the width direction by the steering operation of the steering roller 205.

There is a possibility that the oil S adhering to the vicinity of the end 205a of the steering roller 205 may adhere to the outer circumferential surface 201c of the fixing belt 201 in a case where the oil regulating member 301 is not provided, as the fixing belt 201 reciprocates in the width direction.

Then, the oil S adhering to the outer circumferential surface 201c of the fixing belt 201 reaches the fixing nip portion N1 as the fixing belt 201 rotates in the B direction of FIG. 6. The oil S that has reached the fixing nip portion N1 adheres to the recording material P conveyed to the fixing nip portion N1. In this case, the region of the recording material P to which the oil S adheres becomes a fixing failure in which heat transfer is hindered and the toner is not sufficiently melted, or an image failure such as gloss unevenness due to a change in gloss feeling caused by the oil S.

In addition, since the fixing device 300 aggressively reciprocates the fixing belt 201 in the width direction by the steering roller 205 in order to suppress the paper edge damage of the fixing belt 201, the exposure of the oil S is promoted. Therefore, it is necessary to suppress the oil S from adhering to the region of the fixing belt 201 in contact with the recording material P.

In the present embodiment, the oil S adhering to the steering roller 205 from the inner circumferential surface 201b of the fixing belt 201 is moved from the end 301b of the oil regulating member 301 in contact with the steering roller 205 toward the end 301a at a predetermined angle θ2. As a result, the oil S adhering to the steering roller 205 from the inner circumferential surface 201b of the fixing belt 201 can be prevented from flowing around the outer circumferential surface 201c of the fixing belt 201.

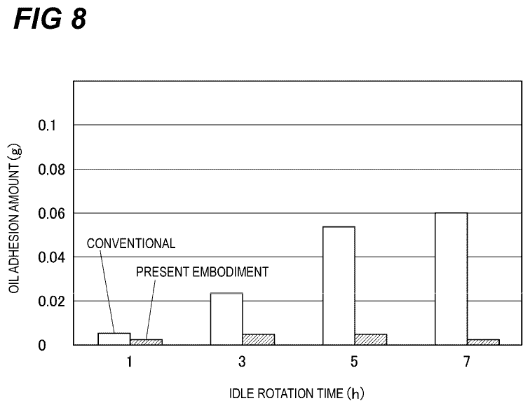

FIG. 8 is a comparison of the amount of oil adhering to the outer circumferential surface 201c of the fixing belt 201 between the conventional fixing device not provided with the oil regulating member 301 and the fixing device 300 of the present embodiment provided with the oil regulating member 301. In FIG. 8, the fixing device 300 is operated under the same conditions as in FIG. 5.

In the conventional case, it can be confirmed from FIG. 8 that the oil S on the inner circumferential surface of the fixing belt gradually moves to the outer circumferential surface of the fixing belt and accumulates on the surface of the steering roller as the idle rotation time increases.

On the other hand, the fixing device 300 according to the present embodiment can perform control such that the oil S to be accumulated in the vicinity of the end 205a of the surface 205b of the steering roller 205 is returned toward the center in the width direction. Accordingly, in the fixing device 300 of the present embodiment, the oil S hardly accumulates the vicinity of the end 205a of the surface 205b of the steering roller 205. Therefore, in the fixing device 300 of the present embodiment, even when the oil S is exposed to the region outside the fixing belt 201, the amount of the oil S adhering to the outer circumferential surface 201c of the fixing belt 201 can be reduced by the oil regulating member 301.

As described above, by providing the oil regulating member 301 with respect to the steering roller 205 abutting on the fixing belt 201, it is possible to suppress the oil S from flowing around the outer circumferential surface 201c of the fixing belt 201 and to suppress the deterioration of the image quality.

The fixing device 300 can cause the oil regulating member 301 to abut at least up to the end 205a of the front surface 205b of the steering roller 205 to flow the oil S to be accumulated in the vicinity of the end 205a to the central portion in the width direction of the steering roller 205. As a result, it is possible to reliably prevent the oil S adhering to the vicinity of the end 205a of the steering roller 205 from moving to the outer circumferential surface 201c of the fixing belt 201.

Since the oil regulating operation by the oil regulating member 240 of the fixing device 300 according to the present embodiment is the same as the oil regulating operation of the fixing device 200, the description thereof will be omitted.

In the present embodiment, the oil regulating member 301 is provided so as to abut on the front surface 205b of the steering roller 205 and is provided at a position straddling at least both ends 201a in the width direction of the fixing belt 201. The oil regulating member 301 is inclined to the downstream in the rotation direction of the steering roller toward the central portion in the width direction of the fixing belt 201. As a result, it is possible to suppress the oil S from adhering to the surface of the fixing belt 201 that abuts on the recording material P, and thus, it is possible to suppress the adhesion of the oil S to the recording material P and to suppress deterioration of image quality.

In the present embodiment, a fluorine rubber sheet is used as the oil regulating member 301, but the present invention is not limited thereto, and a member other than the fluorine rubber sheet may be used as the oil regulating member 301.

Further, in the present embodiment, the abutting position of the oil regulating member 301 with respect to the steering roller 205 can be set to an arbitrary position.

In the present embodiment, the angle of the oil regulating member 301 with respect to the width direction is set to 10 degrees, but the present invention is not limited thereto, and the angle of the oil regulating member 301 with respect to the width direction can be set to an angle other than 10 degrees.

In the present embodiment, the start point of the oil regulating member 301 is located at the position of the end 205a of the steering roller 205, but the present invention is not limited thereto, and the start point of the oil regulating member 240 may be located outside the end 205a of the steering roller 205 in the width direction.

It goes without saying that the present invention is not limited to the above embodiment, and various modifications can be made without departing from the gist of the present invention.

Specifically, in the first embodiment and the second embodiment, the oil regulating member 240 or the oil regulating member 301 abutting on the heating roller 204 or the steering roller 205 is provided. However, the invention is not limited thereto, and the oil regulating member may be provided on a rotating member other than the heating roller 204 and the steering roller 205 provided inside the fixing belt 201 and abutting on the inner circumferential surface 201b of the fixing belt 201.

Specifically, in the first embodiment and the second embodiment, the inner circumferential surface 201b of the fixing belt 201 is heated, but the invention is not limited thereto, and the outer circumferential surface 201c of the fixing belt 201 may be heated.

In the first and second embodiments, the fixing belt 201 is moved in the width direction, but the present invention is not limited thereto, and the fixing belt 201 may not be moved in the width direction when the recording material P having the maximum size is conveyed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-107345, filed Jul. 3, 2024, which is hereby incorporated by reference herein in its entirety.

What is claimed is:

1. A fixing device that fixes a toner image on a recording material, the fixing device comprising:
a rotatable endless belt member including a first surface that abuts on the recording material and a second surface opposite the first surface and to which a lubricant is applied;
a nip forming member provided inside the belt member;
a pressure rotating body configured to form a fixing nip portion that nips and conveys the recording material together with the belt member by pressurizing the nip forming member via the belt member;
a rotatable rotating member including a third surface that abuts on the second surface of the belt member; and
a lubricant regulating member configured to abut on the third surface of the rotating member and provided at a position straddling each of at least both ends of the belt member in a width direction perpendicular to the conveying direction of the recording material, and inclined downstream in a rotation direction of the rotating member toward the central portion in the width direction of the belt member.

2. The fixing device according to claim 1, wherein
the rotating member is a heating member that warms the belt member.

3. The fixing device according to claim 1, further comprising
a steering roller that abuts on an inner circumferential surface of the belt member and swings to move the belt member to a predetermined position in the width direction.

4. The fixing device according to claim 3, wherein
the lubricant regulating member is provided across a moving width of an end of the belt member in the width direction when the belt member moves in the width direction by swinging of the steering roller.

5. The fixing device according to claim 1, wherein
the rotating member is a steering roller that swings to move the belt member in the width direction.

6. The fixing device according to claim 1, wherein
the belt member is movable in the width direction, and
the lubricant regulating member is provided at a position straddling a movement range in the width direction of each of both ends of the belt member in the width direction.

7. The fixing device according to claim 1, wherein
the lubricant is oil.

8. The fixing device according to claim 1, wherein
the lubricant regulating member abuts on the third surface of the rotating member at least up to the end in the width direction of the rotating member.

9. A fixing device that fixes a toner image on a recording material, the fixing device comprising:
a rotatable endless belt member including a first surface that abuts on the recording material and a second surface opposite the first surface and to which a lubricant is applied;
a nip forming member provided inside the belt member;
a pressure rotating body configured to form a fixing nip portion that nips and conveys the recording material together with the belt member by pressurizing the nip forming member via the belt member;
a rotatable rotating member including a third surface that abuts on the second surface of the belt member; and
a lubricant regulating member configured to abut on the third surface of the rotating member and scrape off the lubricant adhering to an outer region of the belt member in the rotating member in the axial direction of the rotating member.

10. The fixing device according to claim 9, wherein
the lubricant regulating member is provided at a position straddling each of at least both ends of the belt member in a width direction perpendicular to the conveying direction of the recording material.

11. The fixing device according to claim 9, further comprising
a steering roller that abuts on an inner circumferential surface of the belt member and swings to move the belt member to a predetermined position in a width direction orthogonal to a conveying direction of the recording material.

12. The fixing device according to claim 11, wherein
the lubricant regulating member is provided across a moving width of an end of the belt member in the width direction when the belt member moves in the width direction by swinging of the steering roller.

13. The fixing device according to claim 9, wherein
the rotating member is a heating member that warms the belt member.
